(19) United States
(12) Patent Application Publication
(10) Pub. No.: US 2006/0105844 A1
(43) Pub. Date: May 18, 2006

(54) Flexible drive adapter

(76) Inventors: Roger L. Sweet, Berlin Heights, OH (US); Hans Burkhardt, Grafton, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/990,701

(22) Filed: Nov. 17, 2004

(51) Int. Cl. F16D 31/00

(52) U.S. Cl. 464/102

(57) ABSTRACT

In one embodiment, a system to compensate for misalignment between a drive shaft and a driven shaft includes a coupling device secured to the driven shaft, a bore in the drive shaft for receiving the coupling device, and a securing device to fasten the coupling device in the bore while permitting lateral movement of the coupling device within the bore to compensate for misalignment between the drive shaft and the driven shaft.

### BACKGROUND

The present invention relates to a coupling device between a rotary drive unit and an accessory. It finds particular application in conjunction with a self centering insert coupling and will be described with particular reference thereto. It will be appreciated, however, that the invention is also amenable to other applications.

Heavy vehicles typically include air compressors used for operating accessories on the vehicle. For example, air compressors on heavy vehicles may drive hydraulic and fuel pumps mounted to an accessory drive flange and/or drive mechanism on a face of the compressor. Currently, standardized female spline couplings are formed into a drive shaft of a compressor and, furthermore, are sized to mate with standardized male spline couplings formed into a driven shaft of the accessory (e.g., the pump). Such drive systems are commonly referred to as “SAE A” or “SAE B” attachment systems. The attachment systems described above do not provide adequate allowance for misalignment between the drive and driven shafts during the coupling process. Therefore, the drive shaft must be designed with little runout, thereby increasing design and manufacturing costs.

One current coupling system uses a “Love Joy” three jaw coupling that includes a shaft with loose fit spline fittings on each end. The loose fittings between the splines act to absorb misalignment between the drive shaft and driven shaft. Other current coupling systems use a “Dog Bone” third member much like a “U” joint on the drive shaft of an automobile. While these coupling systems do act to compensate for misalignment between the drive and driven shafts, drawbacks do exist. For example, a seal in the driven device (e.g. the fuel pump) housing the driven shaft may be compromised when the drive shaft is misaligned with the driven shaft. Such a compromised seal may create a passage for fluid (e.g., oil) to escape from the driven device.

### SUMMARY

In one aspect of the present invention, it is contemplated to compensate for misalignment between a drive shaft and a driven shaft.

In one embodiment, a system to compensate for misalignment between a drive shaft and a driven shaft includes a coupling device secured to the driven shaft, a bore in the drive shaft for receiving the coupling device, and a securing device to fasten the coupling device in the bore while permitting lateral movement of the coupling device within the bore to compensate for misalignment between the drive shaft and the driven shaft.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates an exploded view of a drive shaft and connector in accordance with one embodiment of the present invention;

FIG. 2 illustrates an exploded view of the connector of FIG. 1, which is secured in the drive shaft, and a driven shaft in accordance with one embodiment of the present invention; and

FIG. 3 is a bottom view of a ring of the connector in accordance with one embodiment of the present invention;

FIG. 4 is a cross-sectional view of the connector taken along the line 4-4 of FIG. 2 in accordance with one embodiment of the present invention;

FIG. 5 is a cross-sectional view of the drive shaft and connector in accordance with another embodiment of the present invention;

FIG. 6 is an isometric, cross-sectional view of the drive shaft and connector in accordance with the embodiment of the present invention illustrated in FIG. 5;

FIG. 7 is a cross-sectional view of the drive shaft and connector in accordance with another embodiment of the present invention;

FIG. 8 is a cross-sectional view of the drive shaft and connector in accordance with another embodiment of the present invention;

FIG. 9 is a cross-sectional view of the drive shaft and connector in accordance with another embodiment of the present invention.

### DETAILED DESCRIPTION OF ILLUSTRATED EMBODIMENT

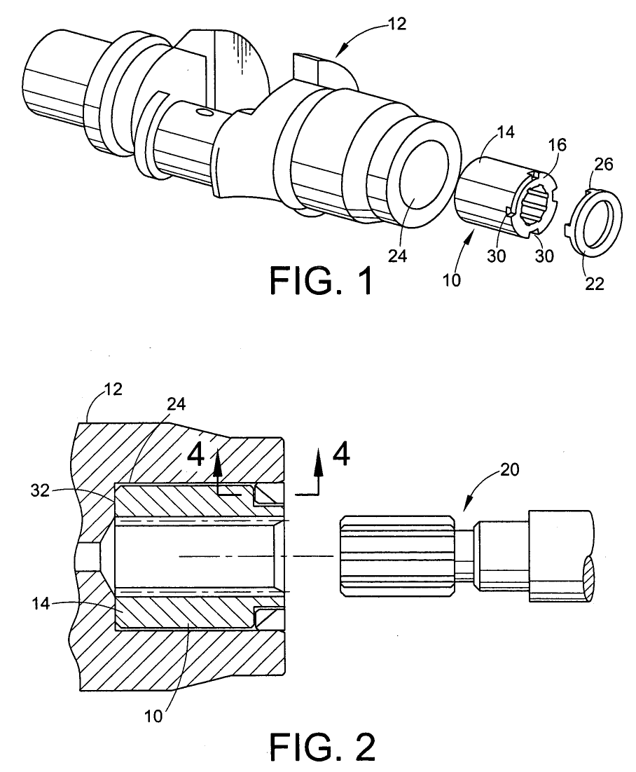

With reference to FIG. 1, an exploded view of a connector 10 and a drive shaft 12 (crank shaft) is illustrated in accordance with one embodiment of the present invention. The connector 10 includes a housing 14 and a coupling 16 within the housing 14. The coupling 16 includes splines for securing the housing 14 to a driven shaft 20 (see FIG. 2) of, for example, an accessory powered by the drive shaft 12.

A ring 22 secures the connector 10 within a bore 24 (cavity) of the drive shaft 12. Therefore, the ring 22 acts as a securing device. More specifically, the ring 22 includes extensions 26 (teeth) that are secured loosely within corresponding pockets 30 in the housing 14. The connector 10 is sized to fit loosely in the bore 24 such that the connector 10 is free to move laterally (e.g., side to side) within the bore 24. In one embodiment, the connector 10 is secured by the ring 22 in the bore 24 such that the connector 10 is substantially prevented from moving longitudinally (e.g., lengthwise) within the bore 24, but is permitted to move laterally within the bore 24. However, other embodiments are also contemplated.

With reference to FIG. 2, the lateral movement of the connector 10 within the bore 24 permits the connector 10 to compensate for misalignment between the drive shaft 12 and the driven shaft 20 when the driven shaft 20 is inserted into the bore 24.

It is to be understood that although the driven shaft 20 is illustrated as a male connector including splines that are sized to mate with splines in a female connector (e.g., the connector 10), it is to be understood that other embodiments, including other types of connections between the driven shaft 20 and the connector 10, are also contemplated.

In one embodiment, the ring 22 is press fitted into the bore 24 of the drive shaft 12. The ring 22 is used to both drive the connector 10 and to hold the connector 10 in the bore 24 of the drive shaft 12.

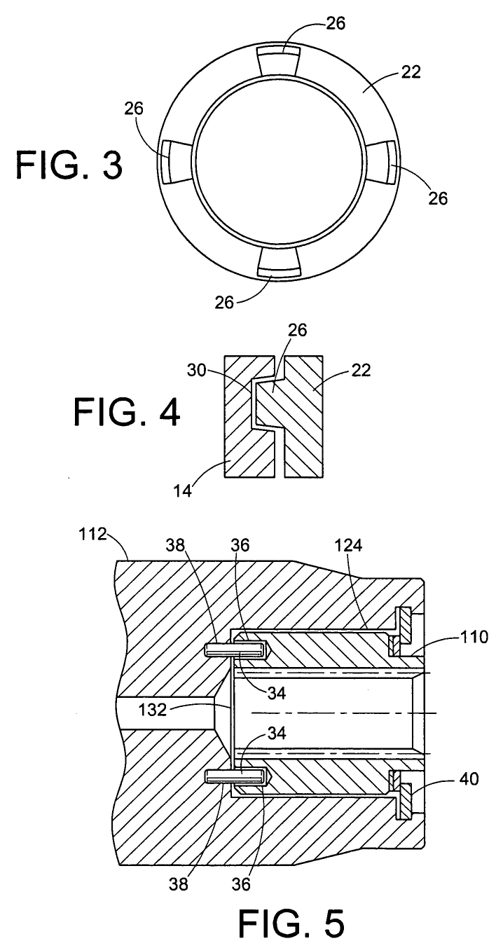

With reference to FIGS. 2-4, the extensions 26 of the ring 22 and the pockets 30 of the connector 10 are shaped with shallow angles to urge the connector 10 to a back wall 32 of the bore 24 of the drive shaft 12. In one embodiment, the angles are between about 5° and about 10°; however, other embodiments are also contemplated. The angles of the extensions 26 and the pockets 30 force the extensions 26 into the pockets 30 as torque is applied to the ring 22.

Although the connector 10 is urged against the back wall 32 of the drive shaft 12, the tolerance between the connector 10 and the bore 24 of the drive shaft 12 permits the connector 10 to move laterally within the bore 24. The lateral movement provides a mechanism to compensate for misalignment between the drive shaft 12 and the driven shaft 20 as the driven shaft 20 is inserted into the bore 24 without excessive side loading of either component. Because the connector 10 floats laterally within the bore 24 of the drive shaft 12 and acts as an adapter between the drive shaft 12 and the driven shaft 20, the connector 10 is also be referred to as a flexible drive adapter.

A second embodiment of the present invention is illustrated in FIG. 5. For ease of understanding this embodiment of the present invention, like components are given numerical references greater by one-hundred than the corresponding components in FIGS. 1-4, and new components are designated by new numerals. With reference to FIG. 5, pins 34 (instead of the rings described with reference to the embodiment described above) are used to control the amount of lateral movement the connector 110 in the bore 124 of the drive shaft 112.

The pins 34 are inserted into respective bores 36, 38 of the connector 110 and the drive shaft 112. A retainer ring 40 (e.g., a snap ring) is used to secure the connector 110 in the bore 124 of the drive shaft 112 and, consequently, the pins 34 in the bores 36, 38 of the connector 110 and the drive shaft 112.

A tolerance between the bores 36, 38 and the pins 34 (along with the tolerance between the connector 110 and the bore 124 of the drive shaft 112 described above) permits the connector 110 to move laterally within the bore 124 of the drive shaft 112 once the connector 110 is secured in the bore 124 using the snap ring 40. As discussed above, the lateral movement of the connector 110 within the bore 124 provides a mechanism to compensate for misalignment between the drive shaft 112 and the driven shaft 20 (see FIG. 2) as the driven shaft is inserted into the bore 124 without excessive side loading of either component. The snap ring 40 and the pins 34 act as a securing device.

In one embodiment, the connector 110 is substantially cylindrically shaped, and the pins 34 are inserted into a flat end of the connector 110, which contacts the back wall 132 of the bore 124.

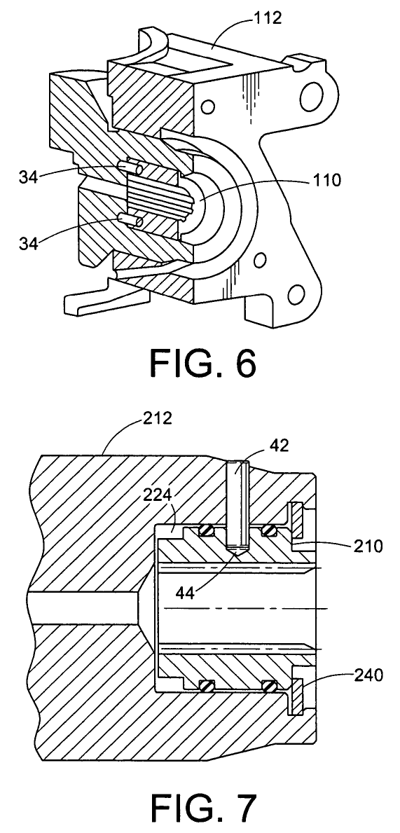

FIG. 6 illustrates an isometric view of the connector 110 secured in the drive shaft 112. A plurality of the pins 34 are illustrated for positioning the connector 110 in the bore 124 of the drive shaft 112.

A third embodiment of the present invention is illustrated in FIG. 7. For ease of understanding this embodiment of the present invention, like components are given numerical references greater by two-hundred than the corresponding components in the FIGS. 1-6, and new components are designated by new numerals. As discussed above, in one embodiment the connector 210 is substantially cylindrically shaped. In the embodiment illustrated in FIG. 7, a pin 42 is secured between a rounded wall of the bore 224 of the drive shaft 212 and a bore 44 of a rounded wall of the connector 210.

A tolerance between the bore 44 of the connector 210 and the pin 42 (along with the tolerance between the connector 210 and the bore 224 of the drive shaft 212 described above) permits the connector 210 to move laterally within the bore 224 of the drive shaft 212 once the connector 210 is secured in the bore 224 using the snap ring 240. As discussed above, the lateral movement of the connector 210 within the bore 224 provides a mechanism to compensate for misalignment between the drive shaft 212 and the driven shaft 20 (see FIG. 2) as the driven shaft is inserted into the bore 224 without excessive side loading of either component.

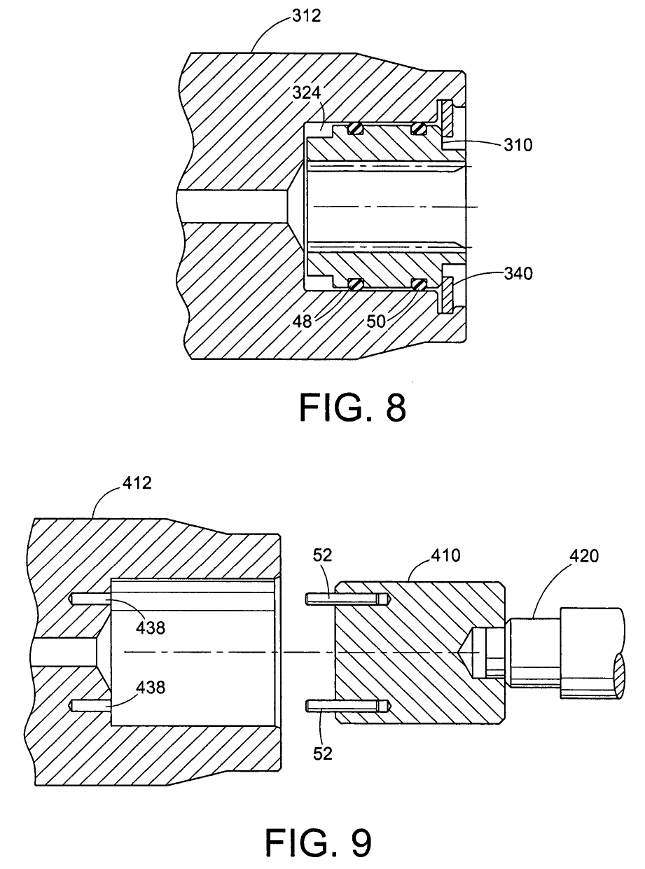

A fourth embodiment of the present invention is illustrated in FIG. 8. For ease of understanding this embodiment of the present invention, like components are given numerical references greater by three-hundred than the corresponding components in the FIGS. 1-4, and new components are designated by new numerals. As discussed above, in one embodiment the connector 310 is substantially cylindrically shaped. In the embodiment illustrated in FIG. 8, O-rings 48, 50 are positioned between the rounded wall of the bore 324 of the drive shaft 312 and the connector 310. Cushioning provided by the O-rings allows for lateral movement of the connector 310 within the bore 324. As discussed above, the lateral movement of the connector 310 within the bore 324 provides a mechanism to compensate for misalignment between the drive shaft 312 and the driven shaft 20 (see FIG. 2) as the driven shaft is inserted into the bore 324 without excessive side loading of either component. In this embodiment, the O-rings 48, 50 and the snap ring 340 act as a securing device.

A fifth embodiment of the present invention is illustrated in FIG. 9. For ease of understanding this embodiment of the present invention, like components are given numerical references greater by four-hundred than the corresponding components in the FIGS. 1-6, and new components are designated by new numerals. In this embodiment, the connector 410 is permanently secured to the driven shaft 420. The diameter of the connector 410 is slightly smaller than the diameter of the bore 424, which allows for misalignment between the connector 410 and the drive shaft 412 when the connector 410 is inserted into the drive shaft 412. Pins 52 on the connector 410 are inserted into bores 438 of the drive shaft 412 as the connector 410 is inserted into the drive shaft 412. An accessory bearing system associated with the driven shaft 420 holds the connector 410 in position.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A flexible drive adapter between a drive shaft and a driven shaft, the flexible drive adapter comprising:
a housing;
a coupling within the housing for securing the housing to the driven shaft; and
means for securing the housing within a cavity of the drive shaft while permitting lateral movement of the housing within the cavity to compensate for misalignment between the drive shaft and the driven shaft.

2. The flexible drive adapter as set forth in claim 1, wherein:
the coupling includes a spline that mates with a spline on the driven shaft.

3. The flexible drive adapter as set forth in claim 2, wherein:
the coupling includes a female spline; and
the driven shaft includes a male spline.

4. The flexible drive adapter as set forth in claim 1, wherein the means for securing includes:
a pin secured to the housing and the drive shaft.

5. The flexible drive adapter as set forth in claim 4, wherein the pin is positioned between an end of the housing and the drive shaft.

6. The flexible drive adapter as set forth in claim 4, wherein:
the housing is cylindrically shaped; and
the pin is secured between a rounded edge of the housing and the drive shaft.

7. The flexible drive adapter as set forth in claim 1, wherein the means for securing includes:
a pocket formed into the housing; and
a ring secured to the drive shaft cooperating with the pocket to secure the housing within the cavity and permit the lateral movement.

8. The flexible drive adapter as set forth in claim 1, wherein the coupling permanently secures the housing to the driven shaft.

9. The flexible drive adapter as set forth in claim 1, wherein the means for securing includes:
an O-ring positioned in the cavity and between the drive shaft and the housing.

10. A connector between a drive shaft and a driven shaft, the connector comprising:
a housing;
a coupling within the housing for securing the housing to the driven shaft; and
a pin secured to the housing and the drive shaft for securing the housing within a cavity of the drive shaft while permitting lateral movement of the housing within the cavity to compensate for misalignment between the drive shaft and the driven shaft.

11. The connector as set forth in claim 10, wherein the pin is secured between an end of the housing and the drive shaft.

12. The connector as set forth in claim 10, wherein:
the housing is substantially cylindrical; and
the pin is secured between a rounded edge of the housing and the drive shaft.

13. A connector between a drive shaft and a driven shaft, the connector comprising:
a housing;
a coupling within the housing for securing the housing to the driven shaft;
a pocket formed into the housing; and
a ring secured to the drive shaft and in the pocket for securing the housing within a cavity of the drive shaft while permitting lateral movement of the housing within the cavity to compensate for misalignment between the drive shaft and the driven shaft.

14. The connector as set forth in claim 13, wherein:
the coupling includes a spline that mates with a spline on the driven shaft.

15. The connector as set forth in claim 14, wherein:
the coupling includes a female spline; and
the driven shaft includes a male spline.

16. The connector as set forth in claim 13, wherein the coupling permanently secures the housing to the driven shaft.

17. A system for compensating for misalignment between a drive shaft and a driven shaft, the system comprising:
a coupling device secured to the driven shaft;
a bore in the drive shaft for receiving the coupling device; and
a securing device to fasten the coupling device in the bore while permitting lateral movement of the coupling device within the bore to compensate for misalignment between the drive shaft and the driven shaft.

18. The system as set forth in claim 17, wherein:
an exterior of the coupling device is substantially cylindrical; and
an inner bore of the coupling device mates with the driven shaft.

19. The system as set forth in claim 17, wherein the coupling device is permanently secured to the driven shaft.

20. The system as set forth in claim 17, wherein the securing device includes a pin secured between the coupling device and the drive shaft.

21. The system as set forth in claim 20, wherein the pin is secured between an end of the coupling device and the drive shaft.

22. The system as set forth in claim 20, wherein:
an exterior surface of the coupling device is substantially cylindrical; and
the pin is secured to the rounded surface of the exterior surface of the coupling device.

23. The system as set forth in claim 17, wherein the securing device includes:
a pocket formed into the coupling device; and
a ring secured to the drive shaft cooperating with the pocket to secure the coupling device within the bore and permit the lateral movement.

24. A method for compensating for misalignment between a drive shaft and a driven shaft, the method comprising:
receiving a coupling device in a cavity of the drive shaft;
fastening the coupling device in the cavity while permitting lateral movement of the coupling device within the cavity to compensate for misalignment between the drive shaft and the driven shaft; and
securing the coupling device to the driven shaft.

25. The method as set forth in claim 24, wherein the fastening includes:
securing a pin between the coupling device and the drive shaft.

26. The method as set forth in claim 25, wherein securing the pin includes:
securing the pin to an end of the coupling device.

27. The method as set forth in claim 25, wherein the coupling device is substantially cylindrical, the securing the pin includes:
securing the pin to a rounded surface of the coupling device.

28. The method as set forth in claim 24, wherein the fastening includes:
securing a ring to the drive shaft, the ring cooperating with a pocket in the coupling device to secure the coupling device within the cavity and permit the lateral movement.

29. A connector between a drive shaft and a driven shaft, the connector comprising:
a coupling device permanently secured to the driven shaft; and
means for securing the coupling device within a cavity of the drive shaft while permitting lateral movement of the coupling device within the cavity to compensate for misalignment between the drive shaft and the driven shaft.

30. The connector as set forth in claim 29, wherein the means for securing includes:
a pin secured to the coupling device and the drive shaft.

31. The connector as set forth in claim 29, wherein the means for securing includes:
a pocket formed into the coupling device, a ring secured to the drive shaft cooperating with the pocket to secure the coupling device within the cavity and permit the lateral movement.
